(19) United States
(12) Patent Application Publication
(10) Pub. No.: US 2007/0178941 A1
(43) Pub. Date: Aug. 2, 2007

(54) Mobile communication apparatus having text presentation capability

(75) Inventors: Yuji Fujimoto, Tokyo (JP); Sachio Fukunaga, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/384,899

(22) Filed: Mar. 20, 2006

(30) Foreign Application Priority Data
Jan. 27, 2006 (JP) 2006-18639

(51) Int. Cl. H04B 1/38

(52) U.S. Cl. 455/566

(57) ABSTRACT

A mobile communication apparatus for presenting text is provided. The mobile communication apparatus includes a first case and a second case movably connected to each other by a connection, the first case having a first face and a second face being back-to-back to each other, and includes a detector for detecting an overlap between the first and the second cases. The mobile communication apparatus includes a display having a screen disposed on the first face, and includes a set of user controls disposed on a face of the second case being opposite the second face while the first and the second cases overlap. The mobile communication apparatus includes a controller for presenting at least a portion of the text on the screen as arranged in a layout larger than the screen, and to present the text in a wrapped manner in a case where the detector detects the overlap.

### CROSS REFERENCE TO RELATED APPLICATIONS

This application is based upon and claims the benefit of priority from the prior Japanese Patent Application No. 2006-018639 filed on Jan. 27, 2006; the entire contents of which are incorporated herein by reference.

### FIELD OF THE INVENTION

The present invention relates to a mobile communication apparatus having text presentation capability, in particular to a mobile communication apparatus having a display configured to present at least a portion of text.

### DESCRIPTION OF THE BACKGROUND

A word processing software product is known which may scroll a portion of text in a window shown on a computer screen and may let a cursor move to a designated passage, in other words a destination, of the text. By the above software, a vertical and a horizontal scroll bars may be provided on the display to scroll, vertically and horizontally, the text arranged in a layout being larger than the computer screen.

The cursor may move to the destination by a jumping function, a searching function, etc. The destination may be determined by selecting a bookmark specifying the destination like a page number, a paragraph marker, a particular alphanumeric character, etc. entered on a pop-up menu, a tool bar, etc. If an operation is done to either jump to or search for the selected bookmark in the pop-up menu, the cursor moves to the destination specified by the bookmark.

A character display device is disclosed in Japanese Patent Publication (Kokai), No. 2005-164683, which is configured to efficiently scroll at least a portion of text on a small-sized screen. The above character display device may present at least a portion of text arranged in a layout being larger than the screen either in a wrapped manner or in a normal (not wrapped) manner according to a user's selection.

In the case of the normal manner, an arrangement of characters forming the text is not modified and a portion of the text is presented on the screen. The presented portion may move left, right, up and down by a user's four-way scrolling operation. In the case of the wrapped manner, the arrangement of characters is modified so that each line of the text is wrapped at a right end and continues to a next line according to and limited by a width of the display. The presented portion of the text may move only up and down by a user's up-down scrolling operation.

While the above word processing software is being used, the cursor moves to the destination specified by the bookmark like the page number, the particular alphanumeric character etc. entered on the pop-up menu. If the cursor jumps to a page specified by the page number, often presented on the screen is only a passage around an upper left end of the page. If the cursor jumps to the particular character, often presented on the display are both passages before and after the bookmark that may be variously placed on the screen.

If the above word processing software is applied to a mobile communication apparatus having a small-sized screen, there may be a problem that a length of the presented passage after the bookmark is too short, as the passage before the bookmark is also presented on the screen. There may also be a problem that it is inconvenient to move the cursor frequently to look over the text as a whole, as the bookmark is variously placed on the screen every time the cursor is moved.

The above character display device needs four keys to scroll the text left, right, up and down in the case of the normal manner, and needs two keys to scroll the text only up and down in the case of the wrapped manner. If the above character display device is applied to a mobile communication apparatus formed by two cases movably connected to each other and having a small-sized screen, there may be a problem that a sufficient number of keys may not be used for scrolling depending on a relative position between the two cases. That may cause another problem that either the wrapped manner or the normal manner may not be selected as desired.

### SUMMARY OF THE INVENTION

Accordingly, an advantage of the present invention is to provide a mobile communication apparatus capable of presenting text on a screen smoothly while the text is arranged in a layout larger than the screen.

To achieve the above advantage, one aspect of the present invention is to provide a mobile communication apparatus capable of presenting text. The mobile communication apparatus includes a first case having a first face and a second face being back to back to each other. The mobile communication apparatus includes a second case having a third face being opposite the second face in a case where the first case and the second case overlap to each other. The mobile communication apparatus includes a connection configured to movably connect the first case and the second case.

The mobile communication apparatus includes a display having a screen disposed on the first face, a set of user controls disposed on the third face and a detector configured to detect an overlap between the first case and the second case. The mobile communication apparatus includes a controller coupled to the display, the set of user controls and the detector. The controller is configured to present the text on the screen as arranged in a layout larger than the screen, and to present the text on the screen in a wrapped manner in a case where the detector detects the overlap.

### BRIEF DESCRIPTION OF THE DRAWINGS

FIG. 1 shows a set of external views of a mobile communication apparatus of the embodiment of the present invention.

FIG. 2 illustrates how to present at least a portion of text on a display of the mobile communication apparatus of the embodiment of the present invention.

FIG. 3 illustrates a plurality of examples appearing on the display of the mobile communication apparatus of the embodiment of the present invention used for selecting an option of a jump after a user's operation to perform a jump.

FIG. 4 illustrates which function is assigned to each of a plurality of side keys of the mobile communication apparatus of the embodiment of the present invention.

FIG. 5 is a block diagram of a main part of the mobile communication apparatus of the embodiment of the present invention.

FIG. 6 is a flow chart of a process of selecting an option of a jump performed by the mobile communication apparatus of the embodiment of the present invention.

FIG. 7 is a flow chart of a process of text presentation performed by a main controller of the mobile communication apparatus of the embodiment of the present invention.

FIG. 8 illustrates an example of a transition of normal presentation performed by the mobile communication apparatus of the embodiment of the present invention.

FIG. 9 illustrates an example of a transition of normal presentation performed by the mobile communication apparatus of the embodiment of the present invention.

### DETAILED DESCRIPTION OF THE INVENTION

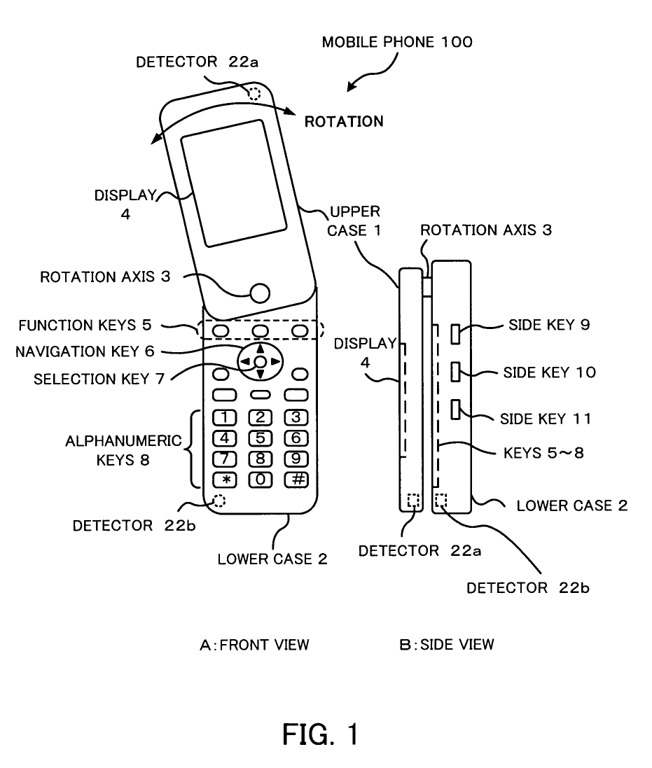

An embodiment of the present invention will be described with reference to FIGS. 1-9. FIG. 1 shows a set of external views (“A: FRONT VIEW” and “B: SIDE VIEW”) of a mobile phone 100, i.e., a mobile communication apparatus of the embodiment of the present invention. The mobile phone 100 has an upper case 1 and a lower case 2 which are movably connected by a rotation axis 3 and rotate to each other.

The front view of FIG. 1 shows the mobile phone 100 in a state where the upper case 1 and the lower case 2 are separate to each other to a certain degree. The side view of FIG. 1 shows the mobile phone 100 in a state where the upper case 1 and the lower case 2 overlap to each other. Disposed is a display 4 having a screen on a front face of the upper case 1 (hereinafter called the upper front face) shown in the front view of FIG. 1. There is a detector 22a in the upper case 1.

Disposed is a first set of user controls on a front face of the lower case 2 (hereinafter called the lower front face) shown in the front view of FIG. 1, which includes a plurality of function keys 5 (shown are three keys in a row in FIG. 1), a four-way navigation key 6 (a four-way arrow indicated), a selection key 7 and a plurality of alphanumeric keys 8. There is a detector 22b in the lower case 2. Disposed is a second set of user controls on a side face of the lower case 2 (hereinafter called the lower side face), which includes a side key 9, a side key 10 and a side key 11.

As shown in the front view of FIG. 1, the upper case 1 may rotate against the lower case 2 around the rotation axis 3, as a minute hand rotates against an hour hand in a clock. Consequently, in a case where the upper case 1 and the lower case 2 overlap to each other, the mobile phone 100 is in a state shown in the side view of FIG. 1.

In the state of the side view of FIG. 1, the screen of the display 4 faces outward and may present a page browsed on the Internet, a document and a TV program, etc. The first set of user controls disposed on the lower front face and including the keys 5-8 described above is, however, hidden by the upper case 1, and may not be operated. Only the second set of user controls disposed on the lower side face and including the side keys 9-11 may be operated.

The detector 22a is formed by a magnetic sensor, e.g. a Hall element, and so is the detector 22b. The detectors 22a and 22b may detect each other while being close to each other, and may thereby detect a degree of an overlap between the upper case 1 and the lower case 2.

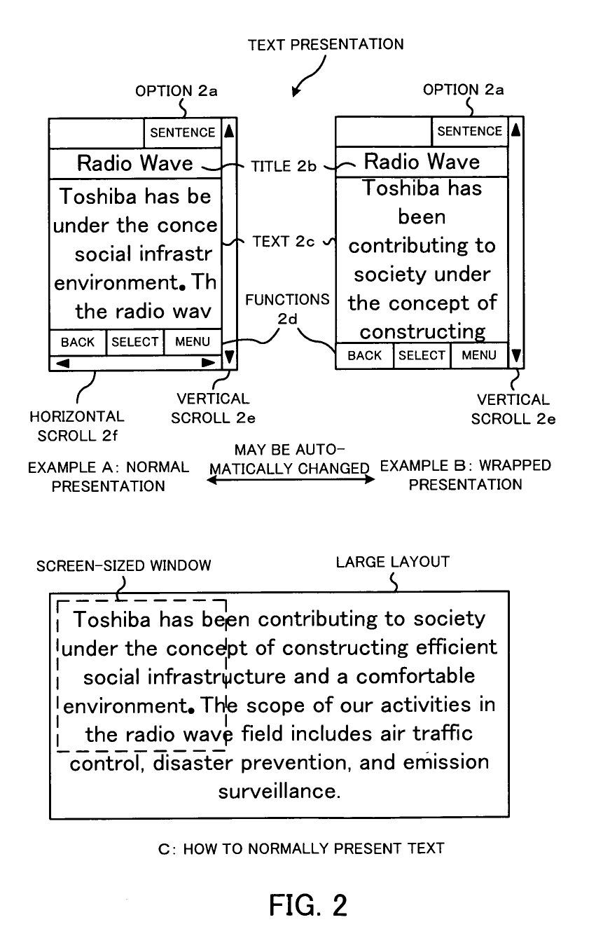

FIG. 2 illustrates how to present a portion of text on the screen of the display 4, i.e. a way of text presentation. A size of a screen of a mobile phone is generally too small to present a sufficient amount of text without scrolling. FIG. 2 shows two examples for text presentation, “A: NORMAL PRESENTATION”, and “B: WRAPPED PRESENTATION”, hereinafter called the example A and the example B, respectively. Each of the example A and the example B is tailored to present text on the screen of the display 4 efficiently and conveniently.

In a lower half of FIG. 2, “C: HOW TO NORMALLY PRESENT TEXT”, shown is a portion of text browsed on the Internet, e.g., and thereby arranged in a layout being larger than the screen of the display 4 (hereinafter called the larger layout). On a portion of the text, a window of a size of the screen of the display 4 (screen-sized window) drawn by a dashed line is assumed to be overlaid. The window-overlaid portion of the text may be viewed through the window and presented on the screen of the display 4 in a normal (not wrapped) manner. Such a manner of text presentation is called normal presentation.

In an area named option 2a included in one of the example A and the example B, shown is an option having been selected of how the screen-sized window jumps (an option of a jump). The area of option 2a shows a selected option of a jump, i.e. how and where a first (upper left) corner of the window jumps from its present position while maintaining a size and a shape of the window. On the example A and the example B shown in FIG. 2, an option of jumping one sentence is assumed to have been selected.

In an area named title 2b, shown is a title of the text. In an area named text 2c, shown is a portion of the text. In an area named functions 2d, shown is a plurality of functions each of which is assigned to one of the function keys 5, the side keys 9-11, etc., respectively. In an area named vertical scroll 2e and an area named horizontal scroll 2f, shown is a vertical scroll bar and a horizontal scroll bar, respectively.

While the normal presentation like the example A is on the screen of the display 4, four of the keys of the mobile phone 100 are required for four-way scrolling, i.e. up, down, left and right. If the upper case 1 and the lower case 2 are separate as shown in the front view of FIG.1, the normal presentation like the example A may be automatically adopted as the keys on the lower front face may be used for four-way scrolling.

In the normal presentation, each line of the text is not wrapped at a right end of the area of text 2c and presented as arranged in the larger layout. Although being inconvenient for interpretation of the text as the presented text is interrupted and discontinues, the normal presentation is suitable in a case where the larger layout of the text should not be modified. Each portion of the text is alternately presented in the area of text 2c by four-way scrolling so that the text may be read as arranged in the larger layout. The presented portion of the text may also be changed after the window jumps as defined in the area of option 2a.

While the normal presentation like the example A is on the screen of the display 4, the keys 5-8 on the lower front face may be operated. The navigation key 6 may be used for vertical scrolling by being pressed up and down, and may be used for horizontal scrolling by being pressed left and right. Each of the functions shown in the area of functions 2d, “BACK”, “SELECT” and “MENU” may be assigned to each of the function keys 5.

While the wrapped presentation like the example B is on the screen of the display 4, two of the keys of the mobile phone 100 are required for vertical scrolling, i.e. up and down. If the upper case 1 and the lower case 2 overlap as shown in the side view of FIG.1, the wrapped presentation like the example B requiring a fewer ways of scrolling may be automatically adopted, as the side keys 9-11 may be used for vertical scrolling but the keys on the lower front face may not.

In the wrapped presentation, each line of the text is wrapped at a right end of the area of text 2c. The wrapped presentation is convenient for interpretation of the text as the presented text continues on the screen of the display 4. As no text exists outside of the right end of the area of text 2c, each portion of the text is alternately presented in the area of text 2c by vertical scrolling without a need of horizontal scrolling. The presented portion of the text may also be changed after the screen-sized window jumps as defined in the area of option 2a.

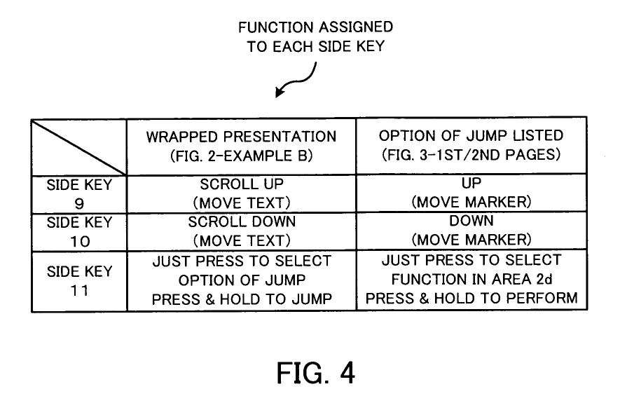

While the wrapped presentation like the example B is on the screen of the display 4, the side keys 9-11 may only be operated. Details about which function is assigned to each of the side keys 9-11 will be described later with reference to FIG. 4.

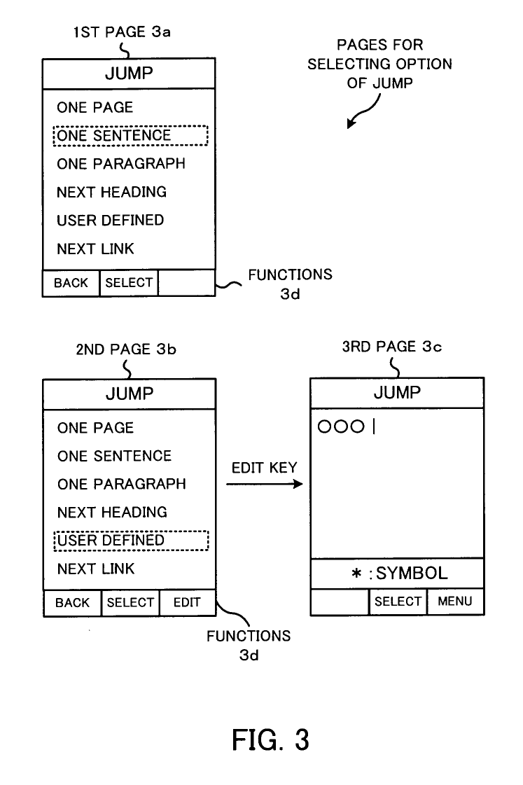

FIG. 3 illustrates a plurality of pages appearing on the screen of the display 4, used for selecting an option of a jump after a user's operation to perform a jump. The pages are a first page 3a, a second page 3b and a third page 3c. The example A shown in FIG. 2 may be changed into one of the pages in FIG. 3 by a menu operation provided in the area of functions 2d, and so may the example B shown in FIG. 2.

The first page 3a shows a plurality of options of a jump. The first corner of the screen-sized window may jump one page, may jump one sentence and may jump one paragraph as selected. The first corner of the window may jump to a next heading of the text, may jump as defined by a user's operation and may jump in the text to a next link to, e.g., a uniform resource locator (URL) of the Internet. On the page 3a, an option of “ONE SENTENCE” is shown surrounded by a dotted rectangular marker and highlighted to be selected. The selected option is shown in the area of option 2a on the example A and the example B shown in FIG. 2.

The window jumps one page by detecting a next turn of pages (one page option). The window jumps one sentence by detecting a next period punctuating the text (one sentence option). The window jumps one paragraph by detecting a start of a new line of the text (one paragraph option). The window jumps to a next heading by detecting a numeral, a symbol, etc., included in the next heading (next heading option). The window jumps as defined by a user's operation by detecting a character string defined by the user (user defined option). The window jumps to a next link by detecting a symbol identifying, e.g., an URL on the Internet (next link option).

If the user defined option is selected, the first page 3a is changed into the third page 3c, and so is the second page 3b. The character string may be entered on the third page 3c and defined by the user.

FIG. 4 illustrates which function is assigned to each of the side keys 9-11 while the wrapped presentation like the example B shown in FIG. 2 is on the screen of the display 4. The side key 9 is used for scrolling up. The side key 10 is used for scrolling down. While the options of a jump are listed on the screen of the display 4 like the first page 3a and the second example 3b shown in FIG. 3, the side key 11 is used for selecting one of the options of a jump one by one by just being pressed for less than one second. The selected option of a jump is shown in the area of option 2a on the example B shown in FIG. 2. The side key 11 is used for performing the jump as selected above by being pressed and held for no less than one second.

The side key 11 may be used for selecting one of the options of a jump by being pressed and held, and may be used for performing the jump by just being pressed. A boundary between “just press” and “press and hold” may be a value other than one second.

FIG. 4 also illustrates which function is assigned to each of the side keys 9-11 while the options of a jump are listed on the screen of the display 4 like the first and the second examples 3a and 3b shown in FIG. 3. The side key 9 and the side key 10 are used for selecting one of the options of a jump by moving the marker highlighting each of the options up and down, respectively. The side key 11 is used for alternately selecting one of the functions shown in the area of functions 3d on the first and the second examples 3a and 3b shown in FIG. 3 by being just pressed. The side key 11 is used for performing the selected function by being pressed and held.

The side key 11 may be used for selecting one of the above functions by being pressed and held. The side key 11 may be used for performing the selected function by being just pressed.

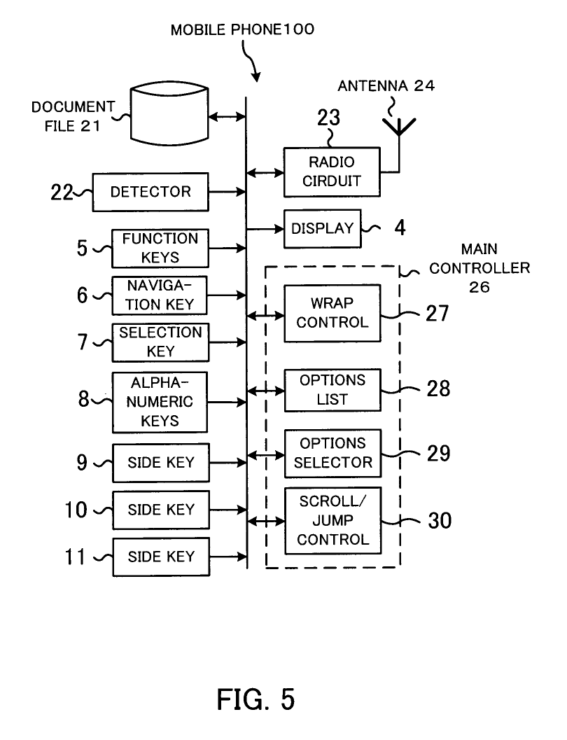

FIG. 5 is a block diagram of a main part of the mobile phone 100 of the embodiment of the present invention, including a plurality of blocks. Each of the blocks having a reference numeral 5-11 is a same as the corresponding one shown in FIG. 1 having the same reference numeral. The mobile phone 100 has a document file 21, a detector 22 formed by the detectors 22a and 22b, the function keys 5, the navigation key 6, the selection key 7, the alphanumeric keys 8, the side keys 9-11, a radio circuit 23, an antenna 24 and the display 4. The mobile phone 100 has a main controller 26 including a wrap control 27, an options list 28, an options selector 29 and a scroll/jump control 30.

The document file 21 is a built-in memory configured to store a document downloaded from the Internet by way of a communication medium, a document created on a personal computer by way of a memory medium, etc. The detector 22 is configured, as earlier described, to detect a degree of the overlap between the upper case 1 and the lower case 2. The keys 5-11 have been explained with reference to FIG. 1 and their explanations are omitted here. The radio circuit 23 and the antenna 24 are configured to send and receive radio signals to and from a base station of a mobile network (not shown). The display 4 is formed by, e.g., a liquid crystal device.

The main controller 26 is configured to entirely monitor and control the mobile phone 100. The wrap control 27 included in the main controller 26 is configured to automatically change the normal presentation like the example A shown in FIG. 2 and the wrapped presentation like the example B shown in FIG. 2.

The options list 28 included in the main controller 26 is configured to store the options of a jump, i.e., the one page option, the one sentence option, the one paragraph option, the next heading option, the user defined option and the next link option. The options selector 29 is configured to set up one of the options of a jump as selected by a user. The scroll/jump control 30 included in the main controller 26 is configured to control the text presentation by scrolling and jumping.

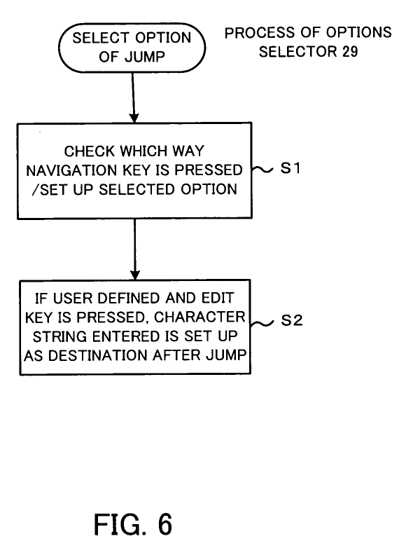

FIG. 6 is a flow chart of a process of the options selector 29 included in the main controller 26 of the mobile phone 100 of the embodiment of the present invention. The options selector 29 checks which way the navigation key 6 is pressed, and sets up one of the options of a jump as selected, e.g., on the first example 3a shown in FIG. 3 (step “S1”).

If the user defined option is selected and one of the function keys 5 to which an editing function is assigned on the second example 3b shown in FIG. 3 (hereinafter called the edit key) is operated, a character string may be entered on the third example 3c shown in FIG. 3 and sets up as a destination to which the window jumps after an operation to perform a jump (step “S2”).

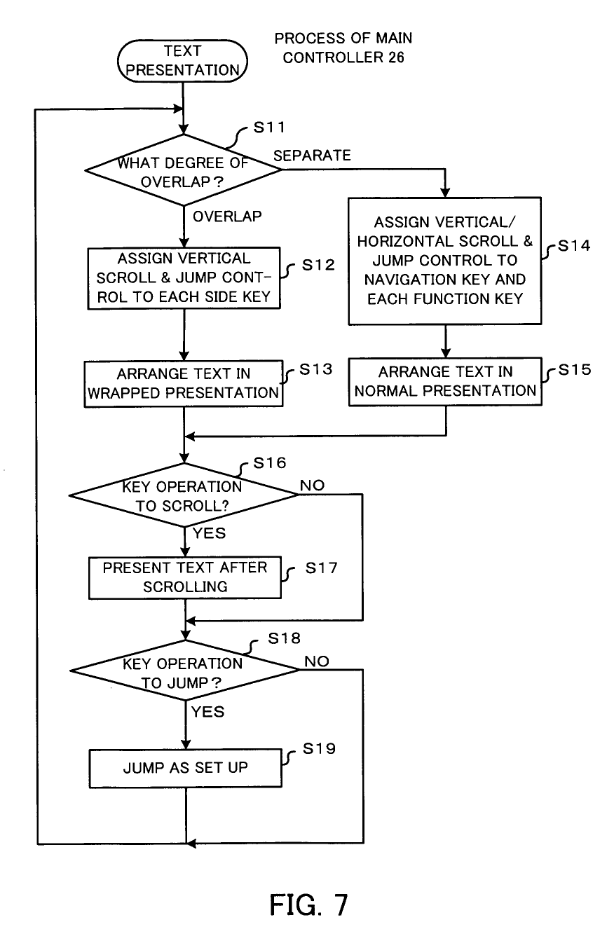

FIG. 7 is a flow chart of a process of the wrap control 27 and the scroll/jump control 30 both included in the main controller 26 of the mobile phone 100 of the embodiment of the present invention. The wrap control 27 checks a degree of the overlap between the first case 1 and the second case 2 detected by the detector 22 (step “S11”).

In a case of the wrapped presentation like the example B shown FIG. 2, and in a case where the options of a jump are listed as in the first example 3a shown in FIG. 3, if the case 1 and the case 2 overlap to each other as the detected degree of the overlap is greater than a threshold, the wrap control 27 assigns each of the functions to each of the side keys 9-11 as shown in FIG. 4 (step “S12”). The wrap control 27 then arranges the text in the wrapped presentation like the example B shown in FIG. 2, and presents the arranged text on the screen of the display 4 (step “S13”).

If the detected degree of the overlap is no greater than the threshold at the step “S11”, the wrap control 27 assigns a function of vertical scrolling and moving a cursor etc. up and down to the navigation key 6 to be pressed up and down, and assigns a function of horizontal scrolling and moving the cursor etc. left and right to the navigation key 6 to be pressed left and right. The wrap control 27 assigns each of the functions shown in the area of functions 2d, “BACK”, “SELECT” and “MENU” to each of the function keys 5 (step “S14”). The wrap control 27 then arranges the text in the normal presentation like the example A shown in FIG. 2, and presents the arranged text on the screen of the display 4 (step “S15”).

The scroll/jump control 30 checks if one of the above keys is operated to which the scrolling function is assigned (step “S16”). If such an operation is done, the scroll/jump control 30 arranges a portion of the text to be presented after scrolling either in the normal or in the wrapped presentation to present on the screen of the display 4 (step “S17”). The scroll/jump control 30 checks if the key is operated to which the jumping function is assigned, e.g., the side key 11 to be pressed and held as shown in FIG. 4 (step “S18”). If such an operation is done, the scroll/jump control 30 performs the jump, e.g., as set up in FIG. 6 (step “S19”).

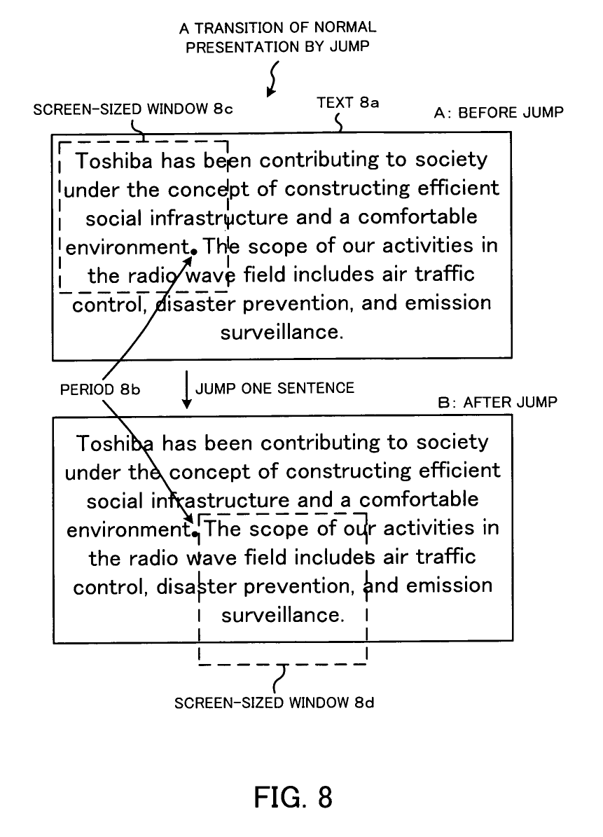

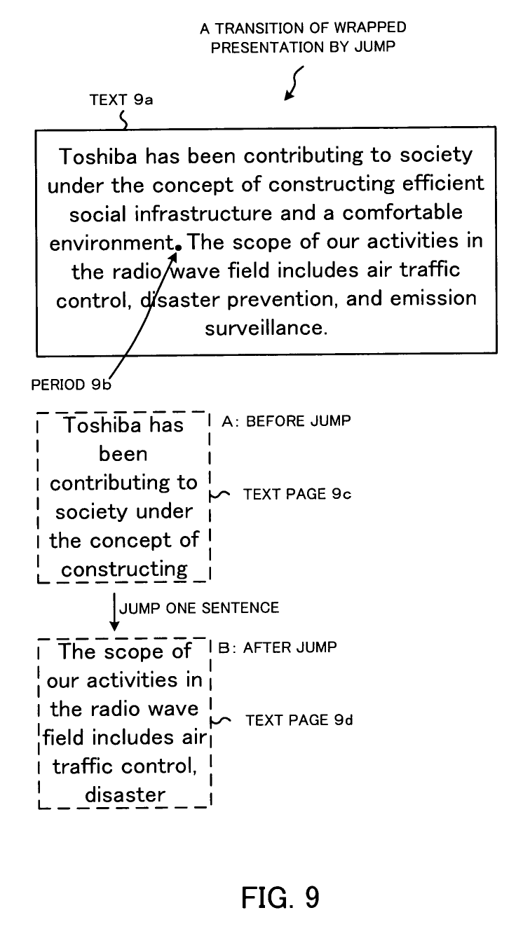

A transition of the normal presentation and of the wrapped presentation caused by a jump will be described with reference to FIG. 8 and FIG. 9, respectively. FIG. 8 illustrates an example of a transition of the normal presentation performed by the mobile phone 100 of the embodiment of the present invention. In an upper half of FIG. 8, “A: BEFORE JUMP”, shown is a portion of text 8a stored in the document file 21 and arranged in the larger layout as earlier described. The text 8a includes a period 8b punctuating one sentence. Overlaid is a screen-sized window 8c drawn by a dashed line being too small to present the text 8a as a whole. In the normal presentation, only a smaller portion of the text 8a is presented on which the screen-sized window 8c is overlaid without modifying the larger layout of the text 8a.

Assume that the one sentence option has been selected for a jump. After a user's operation to perform a jump, the scroll/jump control 30 included in the main controller 26 searches for a period in the text 8a. The scroll/jump control 30 arranges a portion of the text 8a to be presented after the jump on the screen of the display 4 locating a period 8b near a first (upper left) corner of the screen-sized window 8c after the jump.

Consequently, the screen-sized window 8c in the first diagram of FIG. 8 is moved and changed into a screen-sized window 8d drawn by a dashed line in a lower half of FIG. 8, “B: AFTER JUMP”. The period 8b is located near a first (upper left) corner of the screen-sized window 8d. The period 8b may be located inside the screen-sized window 8d, although being located outside in FIG. 8.

FIG. 9 illustrates an example of a transition of the wrapped presentation performed by the mobile phone 100 of the embodiment of the present invention. In an upper half of FIG. 9, shown is a portion of text 9a stored in the document file 21 and arranged in the larger layout as earlier described.

In the wrapped presentation, a smaller portion of the text 9a to be presented on the screen of the display 4 is arranged in a modified layout, where each line is wrapped at a right end and continues to a next line shown as a text page 9c, “A: BEFORE JUMP”, drawn by a dashed line in FIG. 9. On the text page 9c, a first portion of the text “Toshiba has” is within the width of the screen-sized window and is presented in a first line, and a next portion of the text “been contributing” is presented in a second and a third rows after being folded. A word “contributing” is lengthy and may be wrapped with a hyphen and placed in the second and the third lines, although being placed only in the third line in FIG. 9.

Assume that the one sentence option has been selected for a jump. After a user's operation to perform a jump, the scroll/jump control 30 included in the main controller 26 searches for a period in the text 9a. The scroll/jump control 30 arranges a portion of the text 9a to be presented on the screen of the display 4 locating a period 9b near a first (upper left) corner of a text page shown after the jump. Consequently, the text page 9c is changed into a text page 9d, “B: BEFORE JUMP”, drawn by a dashed line in FIG. 9. The period 9b is located near a first (upper left) corner of the text page 9d. The period 9b may be located inside the text page 9d, although being located outside in FIG. 9.

In a case where one of the other options of a jump (one page, one paragraph, next heading, user defined, and next link) has been selected for a jump in FIG. 8 and in FIG. 9, a character, a symbol, etc. detected by the scroll/jump control 30 is located near the first corner of the screen-sized window 8d and of the text page 9d, respectively, after the jump. A next link detected in a case of the next link option may be located at a lower end of the screen-sized window 8d and of the text page 9d.

In the above description, the normal presentation and the wrapped presentation are alternately changed depending on a degree of the overlap between the upper case 1 and the lower case 2. The normal presentation and the wrapped presentation may be alternately changed depending on how many keys may be operated.

The second set of user controls is not limited to the side keys 9-11, and may include a different kind of key that may be operated while the upper case 1 and the second case 2 overlap to each other.

According to the embodiment of the present invention described above, a radio communication apparatus may present on a small-sized screen a portion of text browsed on the Internet, created on a personal computer, etc. and thereby arranged in a layout being larger the screen. The radio communication apparatus may be capable of an automatic alternation of the normal presentation and the wrapped presentation, may be capable of assigning one of a scrolling and a jumping function to a key automatically, and thereby may improve operability of text presentation while scrolling and jumping.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A mobile communication apparatus capable of presenting text, comprising:
a first case having a first face and a second face being back to back to each other;
a second case having a third face being opposite the second face in a case where the first case and the second case overlap to each other;
a connection configured to movably connect the first case and the second case;
a display having a screen disposed on the first face;
a set of user controls disposed on the third face;
a detector configured to detect an overlap between the first case and the second case; and
a controller coupled to the display, the set of user controls and the detector, the controller being configured to present the at least a portion of the text on the screen as arranged in a layout larger than the screen, and configured to present the text on the screen in a wrapped manner in a case where the detector detects the overlap.

2. A mobile communication apparatus capable of presenting text, comprising:
a first case having a first face and a second face being back to back to each other;
a second case having a third face being opposite the second face in a case where the first case and the second case overlap to each other;
a connection configured to movably connect the first case and the second case;
a display having a screen disposed on the first face;
a first set of user controls disposed on the third face;
a detector configured to detect an overlap between the first case and the second case;
a controller coupled to the display, the first set of user controls and the detector, the controller being configured to present at least a portion of the text on the screen as arranged in a layout larger than the screen by scrolling at least in a first direction and in a second direction, the second direction being perpendicular to the first direction, and configured to present the text on the screen in a wrapped manner in a case where the detector detects the overlap; and a second set of user controls coupled to the controller, the second set of user controls being configured to be operated to have the screen scroll in the first direction in the case where the detector detects the overlap.

3. The mobile communication apparatus of claim 2, further comprising an additional controller coupled to the display, the first set of user controls and the second set of user controls, the additional controller being configured to have the screen scroll so that a portion of the text starting a designated character is presented on the screen, if a designated element of one of the first set of user controls and the second set of user controls is operated.

4. The mobile communication apparatus of claim 2, further comprising an additional controller coupled to the display, the first set of user controls and the second set of user controls, the additional controller being configured to have the screen scroll so that a portion of the text ending with a designated character is presented on the screen, if a designated element of one of the first set of user controls and the second set of user controls is operated.

5. The mobile communication apparatus of claim 2, further comprising a first additional controller and a second additional controller,
the first additional controller coupled to the display, the first set of user controls and the second set of user controls, the first additional controller being configured to have the screen scroll so that a portion of the text starting a designated character is presented on the screen if a designated element of one of the first set of user controls and the second set of user controls is operated, the designated character being selectable out of a plurality of characters and a plurality of character strings, and
the second additional controller coupled to the detector and the second set of user controls, the second additional controller being configured to change the designated character every time the second set of user controls is operated in the case where the detector detects the overlap.

6. The mobile communication apparatus of claim 2, further comprising a first additional controller and a second additional controller,
the first additional controller coupled to the display, the first set of user controls and the second set of user controls, the first additional controller being configured to have the screen scroll so that a portion of the text ending with a designated character is presented on the screen if a designated element of one of the first set of user controls and the second set of user controls is operated, the designated character being selectable out of a plurality of characters and a plurality of character strings, and
the second additional controller coupled to the detector and the second set of user controls, the second additional controller being configured to change the designated character every time the second set of user controls is operated in the case where the detector detects the overlap.

7. A mobile communication apparatus capable of presenting text, comprising:
a first case having a first face and a second face being back to back to each other;
a second case having a third face being opposite the second face in a case where the first case and the second case overlap to each other;
a connection configured to movably connect the first case and the second case;
a display having a screen disposed on the first face and being configured to present at least a portion of text arranged in a layout larger than the screen by scrolling at least in a first direction and in a second direction, the second direction being perpendicular to the first direction;
a first set of user controls disposed on the third face;
a detector configured to detect an overlap between the first case and the second case;
a first controller coupled to the display, the first set of user controls and the detector, the first controller being configured to present at least a portion of the text on the screen as arranged in a layout larger than the screen, and configured to present the text on the screen in a wrapped manner in a case where the detector detects the overlap;
a second set of user controls coupled to the controller, the second set of user controls having a first key and a second key both configured to be operated at least in the case where the detector detects the overlap, and
a second controller coupled to the display and the second set of user controls, the second controller configured to have the screen scroll in the first direction if the first key is pressed, and to have the display scroll so that a portion of the text starting a designated character is presented on the display if the second key is pressed.

8. The mobile communication apparatus of claim 1, wherein the detector detects the overlap while the second face and the third face are being opposite and close to each other.

9. The mobile communication apparatus of claim 2, wherein the detector detects the overlap while the second face and the third face are being opposite and close to each other.

10. The mobile communication apparatus of claim 7, wherein the detector detects the overlap while the second face and the third face are being opposite and close to each other.
